(19) United States
(12) Patent Application Publication
(10) Pub. No.: US 2026/0036055 A1
(43) Pub. Date: Feb. 5, 2026

(54) BLADE FOR A TURBOMACHINE TURBINE, AND CORRESPONDING ROTOR, TURBINE AND TURBOMACHINE

(71) Applicant: SAFRAN AIRCRAFT ENGINES, Paris (FR)

(72) Inventors: Baptiste Dorian LAWNICZEK, Moissy-Cramayel (FR); Yannick DURAND, Moissy-Cramayel (FR); Patrice Jean-Marc ROSSET, Moissy-Cramayel (FR)

(73) Assignee: SAFRAN AIRCRAFT ENGINES, Paris (FR)

(21) Appl. No.: 19/150,051

(22) PCT Filed: Jan. 18, 2024
(86) PCT No.: PCT/FR2024/050070

§ 371 Date: Jul. 22, 2025

(30) Foreign Application Priority Data
Jan. 26, 2023 (FR) FR2300738

(51) Int. Cl. F01D 5/22; F01D 5/28; F01D 5/32

(52) U.S. Cl. CPC F01D 5/22; F01D 5/282; F01D 5/323; F05D 2260/96

(57) ABSTRACT

A blade intended to be mounted on a turbomachine rotor with an axis, the blade including a root configured to be mounted in a groove that opens to the outer periphery of a disk of the turbomachine rotor; an airfoil extending the root, in a radial direction with respect to the axis, and having an aerodynamic profile; a radially inner platform separating the airfoil from the root; a heel which extends as a continuation of the airfoil at a free radial end of the blade, at the end of the airfoil radially opposite the root, the heel including a radially outer platform, wherein the heel includes means for locking the radially outer platform with respect to another circumferentially adjacent radially outer platform.

### FIELD OF THE INVENTION

The present invention relates to the field of turbomachinery.

More specifically, the invention relates to a turbomachine blade intended to be fitted in particular in a turbine, and for example a low-pressure turbine.

The invention relates to all types of aircraft turbine engines, in particular turbojet engines and turboprops.

### PRIOR ART

A turbomachine turbine extending along a main axis defining an axial direction, for example a low-pressure turbine, consists of a plurality of stages each formed of a rotor wheel and a nozzle. The nozzle of a turbine comprises a plurality of fixed vanes intended to direct the flow of gas coming from the combustion chamber.

In turn, the rotor wheel comprises a plurality of blades. A blade comprises, as described for example in document FR 3 026 429 A1, a root topped by a radially inner platform, and an airfoil extending radially from the radially inner platform of the root and delimiting a flow path in which the gases of the turbomachine flow during operation, from upstream to downstream along the axial direction of the turbomachine.

A blade may also comprise, as described in document FR 3 073 000 A1, a heel extending at an end of the airfoil opposite to the airfoil root, so that the airfoil is delimited by the radially inner platform of the root and by the heel.

Since these blades are exposed to high temperatures during operation, they can be made of composite materials, and in particular ceramic matrix composite materials. Indeed, compared to metal alloys, such materials may have improved resistance to high temperatures while weighing less. Thus, it is known from the prior art to produce blades for turbomachine rotors from composite material, and in particular from ceramic matrix composite material. A method for manufacturing such a blade is described, for example, in document WO 2010 061140 A1.

The turbine is, in a known manner, subjected to many stresses, in particular vibrations, which can cause movements between the different parts and therefore a malfunction.

A known solution for limiting the vibratory stresses on the blades of a turbine involves introducing contact between two circumferentially adjacent blades so as to hold them in position in pairs. The vibrations of the blade during operation induce relative slip at this contact, which, combined with the contact pressures, creates vibration damping by friction.

Implementations are known wherein the two lateral faces of each of the heels have a specific cut-out so that a lateral face of the heel has a shape complementary to a lateral face of a heel of a circumferentially adjacent blade. Thus, such contact is generated on these blades through an angular deformation of the airfoil.

For example, a heel may have a protrusion on the top surface and a complementary indentation on the bottom surface so as to cooperate with the two circumferentially adjacent blades.

Moreover, and in the case of blades made of a ceramic matrix composite material, the acceptable mechanical stresses are relatively low, which means that the blades are not very tolerant of the stresses generated by contact between circumferentially adjacent blades.

Added to this relative tolerance is the fact that ceramic matrix composite materials expand approximately three times less than metallic materials, which can result in a reduction in the contact force during operation due to the non-expansion of blades made of ceramic matrix composite material.

Hence, there is a need to find an alternative solution to provide damping for the blades.

### DISCLOSURE OF THE INVENTION

The invention aims to at least partly overcome the aforementioned drawbacks relating to the prior art.

To do this, the invention relates to a blade intended to be mounted on a turbomachine rotor with an axis X, the blade comprising:
a root configured to be mounted in a groove that opens to the outer periphery of a disk of the turbomachine rotor;
an airfoil extending said root, in a radial direction R with respect to the axis X, and having an aerodynamic profile;
a radially inner platform separating said airfoil from said root;
a heel which extends as a continuation of said airfoil at a free radial end of said blade, at the end of the airfoil radially opposite the root, said heel comprising a radially outer platform,

According to the invention, said heel comprises means for locking the radially outer platform with respect to another circumferentially adjacent radially outer platform, the locking means comprising two locking walls for locking the radially outer platform each configured to receive a circumferential end of a locking plate.

Thus, the invention proposes an approach that at least partially solves some of the drawbacks of the prior art.

In particular, the embodiment of such locking means makes it possible to limit the vibratory stresses and therefore to dampen the movement of each of the blades with respect to the circumferentially adjacent blades while limiting the stresses applied to the structure of the heel and the blade. Furthermore, this makes it possible to reduce the effects due to the expansion of the different elements regardless of the materials used to make these elements.

It should be noted that the locking walls are also referred to below by the term fastening walls, or by the term walls.

According to one particular aspect of at least one embodiment of the invention, the locking walls of the radially outer platform extend obliquely while being inclined and opposite with respect to the radial direction R.

This makes it possible to use simple mechanical means that do not require the functional part of a blade to be modified so as not to disrupt its correct operation.

According to one particular aspect of at least one embodiment of the invention, the fastening walls are each inclined obliquely with respect to said radial axis R at an angle between 0° and 60°.

According to one particular aspect of at least one embodiment of the invention, the fastening walls are symmetrical with respect to said radial axis R.

According to a particular aspect of at least one embodiment of the invention, said radially outer platform has a width in the circumferential direction, said walls extending from a median portion of the width of said radially outer platform.

According to one particular aspect of at least one embodiment of the invention, said heel carries an upstream tab and a downstream tab that extend radially outward from the radially outer platform, the locking means being arranged axially between the upstream and downstream tabs.

According to one particular aspect of at least one embodiment of the invention, the blade is at least partially composed of a ceramic matrix composite material.

The invention also relates to a turbomachine rotor with an axis X, comprising at least two blades according to one of the aforementioned embodiments, circumferentially adjacent, and a locking plate, one of said two locking walls of the first one of said two blades and one of said two locking walls of the second one of said two blades each receiving a circumferential end of the locking plate.

According to one particular aspect of at least one embodiment of the invention, the locking plate comprises beveled circumferential ends configured to come into contact with said two locking walls of the radially outer platform.

According to a particular aspect of at least one embodiment of the invention, said beveled circumferential ends are connected by a flat portion.

The invention also relates to a turbomachine turbine comprising a rotor according to the aforementioned embodiment.

The invention also relates to a turbomachine for an aircraft comprising a turbine according to the aforementioned embodiment.

### DESCRIPTION OF THE FIGURES

The invention, as well as the different advantages it has, will be more easily understood in light of the following description of an illustrative and non-limiting embodiment thereof, and from the appended drawings wherein:

FIG. 1 is a schematic sectional view of a turbomachine;

FIG. 2 is a side perspective view of a rotor portion according to one embodiment of the invention, two circumferentially adjacent blades being shown;

FIG. 3 is a front perspective view of the two circumferentially adjacent blades of FIG. 2;

FIG. 4 is a perspective view of a blade according to the embodiment of FIG. 2, and

FIG. 5 is a perspective view of a tenon according to the embodiment of FIG. 2.

### DETAILED DESCRIPTION OF AN EMBODIMENT OF THE INVENTION

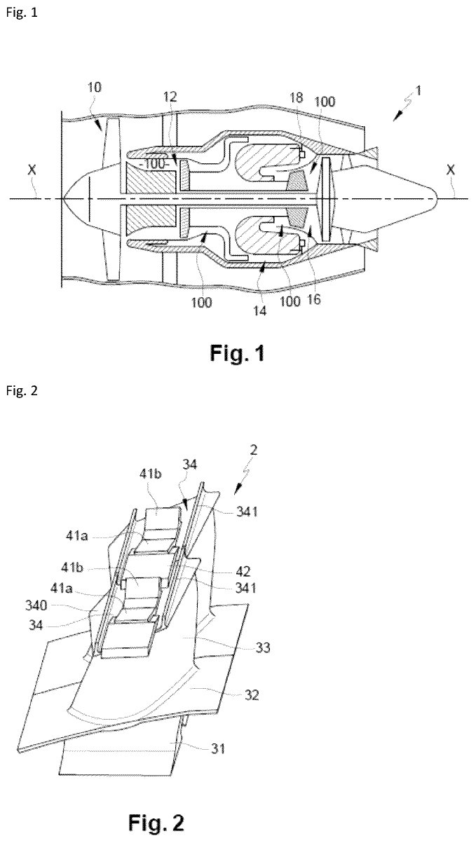

It should be noted that the invention applies to high-pressure and/or low-pressure turbines of a turbomachine, such as the turbomachine shown in FIG. 1.

This turbomachine 1, which extends along an axis X, is, for example, intended to be mounted on an aircraft (not shown), such as an airplane or a helicopter, for example under the wing of the aircraft, on the wing or at the rear of the fuselage of the aircraft.

The turbomachine 1 illustrated in FIG. 1 is a direct-drive, twin-spool turbofan engine. However, this is not limiting since the turbomachine 1 may not be intended to be mounted on an aircraft, may be another type of turbojet, such as a geared turbofan, a turboprop or an auxiliary power unit (or APU). Throughout the description, an axial direction corresponds to the direction of the longitudinal axis X and a radial direction is a direction perpendicular to the longitudinal axis X and intersecting the longitudinal axis X. Similarly, an axial plane is a plane containing the longitudinal axis X and a radial plane is a plane perpendicular to the longitudinal axis X.

Similarly, the adjectives “internal” (or “inner”) and “external” (or “outer”) are used with reference to a radial direction so that the internal portion of an element is, in a radial direction, closer to the longitudinal axis X than the external portion of the same element.

In addition, unless specified otherwise, the terms “upstream” and “downstream” are used with reference to the general direction of gas flow through the turbomachine during operation.

As shown in FIG. 1, the turbomachine 1 comprises, from upstream to downstream, a fan 10, a compressor section 12, a combustion chamber 14 and a turbine section 16. The longitudinal axis X forms the axis of rotation of at least part of the compressor section 12 and the turbine section 16, which can be rotated about the longitudinal axis X with respect to a casing 18 of the turbomachine 1.

In operation, the gases flow inside the turbomachine from upstream to downstream of the turbomachine, along the longitudinal axis X. The fan 10 draws in an air flow, a portion of which, flowing within a primary flow path 100, is successively compressed within the compressor section 12, ignited within the combustion chamber 14, and expanded within the turbine section 16 before being ejected from the turbomachine 1. In this way, the turbomachine 1 generates a thrust. Moreover, this thrust can, for example, be used for the benefit of the aircraft on which the turbomachine 1 is mounted and fastened.

The compressors and the turbines consist in particular of one or more modules, each of these modules comprising a plurality of stages each comprising a rotor and a stator. The nozzle of a turbine comprises a plurality of vanes intended to direct the flow of gas coming from the combustion chamber.

For its part, the turbine rotor of a turbomachine comprises a disk carrying a plurality of blades on its periphery. These blades are evenly distributed around the X axis of the turbomachine and are inserted into housings provided on the periphery of the rotor disk.

A first embodiment of these blades of the invention is now described, with reference to FIGS. 2 to 5.

In this embodiment, each of these blades is at least partially composed of a ceramic matrix composite material.

However, embodiments could be provided in which the blades are made of another material, such as a metal or a metal alloy, capable of withstanding the operating temperatures of such a turbomachine.

Each of the blades 3 comprises:
a root 31 configured to fit into a groove (not shown) that opens to the outer periphery of the turbine rotor disk 2 of the turbomachine;
an airfoil 33 extending the root 31 in a radial direction R with respect to the axis X and having an aerodynamic profile, and
a radially inner platform 32 separating the airfoil 33 from the root 31.

Each of these blades 3 also comprises a heel 34 which extends as a continuation of the airfoil 33 to a free radial end of the blade 3, and which comprises a radially outer platform 40.

It should be noted that the radially inner platform 32 as well as the radially outer platform 40 delimit the airfoil and define the radial width of the flow path.

The heels of the blades have an identical circumferential width and are joined edge to edge circumferentially in a tangential direction.

More specifically, in the embodiment shown, the tangential width of the heel corresponds to the tangential width of the radially outer platform.

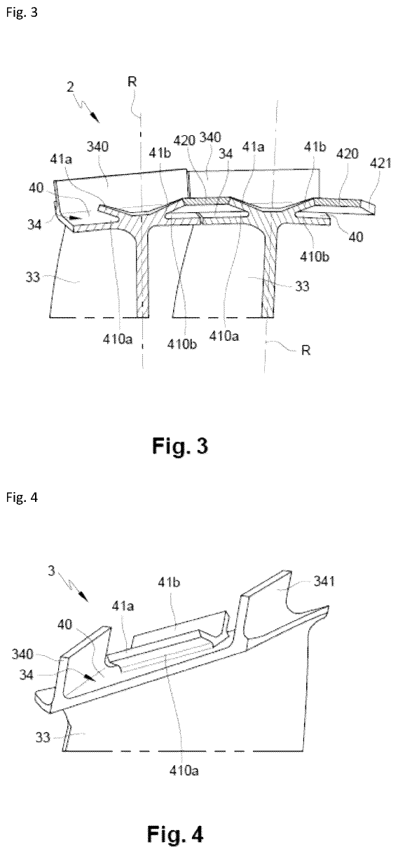

As shown in particular in FIGS. 3 and 4, the heel 34 carries, in this embodiment, two tabs 340, namely an upstream tab and a downstream tab. They extend radially protruding outwardly from the radially outer platform 40, near the upstream and downstream ends of the heel, so as to be outside the flow path.

These two tabs are herein identical so that they are inclined in the same direction and at the same angle.

In order to limit the vibratory stresses on the blades, the heel of each blade comprises means for locking the radially outer platform with respect to another circumferentially adjacent radially outer platform.

In other words, in the rotor, two circumferentially adjacent blades are held in position relative to one another at their radially outer platform by locking means carried by the heel, these locking means being configured to each receive a circumferential end of a locking plate 42.

Thus, according to the invention, the heel 34 of each blade comprises two locking walls 41a, 41b. The locking means are provided at the radially outer platform of the heel, i.e. outside the area of the flow path so as not to interfere with the operation of the turbomachine.

These two locking walls of the radially outer platform are configured to each receive a circumferential end of a locking plate 42.

These walls are herein centered with respect to said tangential width of the heel 34.

In other words, the walls 41a, 41b extend here from a center of the radially outer platform 40 relative to the tangential width.

In other words, the walls extend from a median portion of the width of the radially outer platform, this radially outer platform having a width in the circumferential direction.

According to other embodiments, the walls could be positioned so as to extend from a position between 10% and 90% of the width of the radially outer platform, so as to leave an edge of about 10% at the ends of the radially outer platform.

Such an edge enables support irrespective of the embodiment of the invention.

Two walls 41a, 41b inclined relative to a radial axis R therefore extend obliquely from the radially outer platform 40.

As illustrated, the two walls 41b herein extend obliquely towards the lateral ends of the heel 34. Lateral end means the ends adjacent to the upstream and downstream ends of the heel carrying the tabs. In this manner, the locking means are arranged axially between the upstream and downstream tabs.

The walls and the radially outer platform 40 thus delimit housings 410a, 410b.

In this embodiment, the walls are symmetrical and therefore opposite with respect to the radial axis R.

According to other embodiments, the walls could each be inclined obliquely with respect to the radial axis R at an angle between 0° and 60°.

According to still other embodiments, the inclination of the walls could also be different. Similarly, according to other embodiments, the two walls could extend over a different length. In order to connect two circumferentially adjacent, or successive, blades, i.e. to lock the radially outer platform of one of the two blades with respect to the radially outer platform of the other of the two blades, the rotor therefore comprises a locking plate 42 for two adjacent blades. More specifically, one of the two locking walls of the first of the two blades and one of the two locking walls of the second of the two blades each receive a circumferential end of the locking plate 42.

Thus, one of the housings 410a, 410b of the first of the two blades and one of the two housings 410a, 410b of the second of the two blades, opposite the housing of the first of the two blades each receive a circumferential end of the locking plate 42.

In this way, the locking plate and the housings form a dovetail mechanical assembly.

This an arrangement allows damping the movement of circumferentially adjacent blades relative to each other.

In particular, the locking means and the locking plate make it possible to dampen a tangential movement of the blades with respect to each other, the movements of a heel of a blade resulting in energy dissipation by friction with the locking plate.

In this embodiment, the locking plate is made from a ceramic matrix composite material. According to other embodiments, the locking plate may be made from a material such as a metal or a metal alloy.

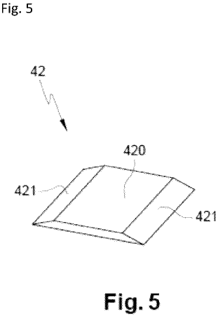

As shown in particular in FIG. 5, the locking plate 42 of the illustrated embodiment is in the form of a trapezoidal prism with two beveled circumferential ends 421 configured to come into contact with the two locking walls 41a, 41b of the radially outer platform 40, and a flat portion 420 connecting these two beveled circumferential ends.

More specifically, and as shown in particular in FIG. 3, the beveled circumferential ends 421 are provided to be accommodated in the housings 410a, 410b.

The shape of the locking plate which is complementary to the shapes of the housings makes it possible to obtain effective locking to dampen a movement of each blade with respect to a circumferentially adjacent blade, and in particular a movement in a circumferential direction. Here, the locking plate has a symmetrical shape with respect to a central axis of this locking plate because the walls are symmetrical with respect to the radial axis R.

In other embodiments, a locking plate having an irregular shape, and in particular not having symmetry, could be envisaged.

For example, a locking plate having a rectangular profile, cooperating with housings formed by walls of substantially complementary shape, could be envisaged.

Locking plates having a rectangular shape on one side and a triangular shape on the other side could also be envisaged.

Alternatively, locking means could be implemented wherein the walls form, together with the locking plate, a dovetail mechanical assembly system with the walls which bear protuberances and the tenon which has protuberances of a complementary shape on its beveled circumferential ends capable of being in contact with the walls.

1. A turbomachine rotor with an axis comprising at least two blades, each blade comprising:
a root configured to be mounted in a groove that opens to the outer periphery of a disk of the turbomachine rotor:
an airfoil extending said root, in a radial direction with respect to the axis, and having an aerodynamic profile:
a radially inner platform separating said airfoil from said root:
a heel which extends as a continuation of said airfoil at a free radial end of said blade, at the end of the airfoil radially opposite the root, said heel comprising a radially outer platform,
each heel comprising means for locking the radially outer platform with respect to another circumferentially adjacent radially outer platform, the locking means comprising two locking walls for locking the radially outer platform each configured to receive a circumferential end of a locking plate,
said two blades being circumferentially adjacent,
said rotor further comprising a locking plate, one of said two locking walls of the first of said two blades and one of said two locking walls of the second of said two blades each receiving a circumferential end of the locking plate,
the locking walls of each radially outer platform of said two blades extending obliquely while being inclined and opposite with respect to the radial direction, and/or the locking plate comprising beveled circumferential ends configured to come into contact with said two locking walls of each radially outer platform.

2. The rotor according to claim 1, wherein each of the locking walls is inclined obliquely with respect to said radial axis at an angle between 0° and 60°.

3. The rotor according to claim 1, wherein the locking walls are symmetrical with respect to said radial axis.

4. The rotor according to claim 1, wherein said radially outer platform has a width in the circumferential direction, said locking walls extending from a median portion of the width of said radially outer platform.

5. Rotor The rotor according to claim 1, wherein said heel carries an upstream tab and a downstream tab which extend radially outward from the radially outer platform, the locking means being arranged axially between the upstream and downstream tabs.

6. The rotor according to claim 1, it wherein the rotor is at least partially composed of a ceramic matrix composite material.

7. The rotor according to claim 1, wherein said beveled circumferential ends are connected by a flat portion.

8. A turbomachine turbine comprising at least one rotor according to claim 1.

9. A turbomachine for an aircraft comprising a turbine according to claim 8.
